(19) United States
(12) Patent Application Publication
(10) Pub. No.: US 2008/0261472 A1
(43) Pub. Date: Oct. 23, 2008

(54) PREPREG, MULTILAYER PRINTED WIRING BOARD AND ELECTRONIC PARTS USING THE SAME

(75) Inventors: Satoru AMOU, Hitachi (JP); Hiroshi Shimizu, Chikusei (JP); Akinori Hanawa, Shimotsuma (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Chemical Co., Ltd.

(21) Appl. No.: 12/105,328

(22) Filed: Apr. 18, 2008

(30) Foreign Application Priority Data
Apr. 18, 2007 (JP) 2007-109246

(51) Int. Cl. B32B 27/04; B32B 5/02; D03D 25/00

(52) U.S. Cl. 442/117; 442/181

(57) ABSTRACT

A prepreg is thermosettable. The prepreg comprises a thermosetting resin composition A, a cured resin of the thermosetting resin composition exhibiting a dielectric tangent of 0.005 or less under 1 Hz or more, and a substrate B into which the resin A is impregnated, wherein the substrate B comprises polyolefin fiber C and a fiber D, which has a tensile strength higher than that of the polyolefin fiber C and a thermal expansion coefficient smaller than that of the fiber C, and wherein the substrate is a woven cloth and has a solubility rate into a hydrocarbon organic solvent is less than 5 wt %.

### CLAIM OF PRIORITY

The present application claims priority from Japanese patent application serial No. 2007-109246, filed on Apr. 18, 2007, the content of which is hereby incorporated by reference into this application.

### FIELD OF THE INVENTION

The present invention relates to a prepreg material for forming an insulating layer with such a low dielectric tangent that satisfies requirements for transmission of high frequency signals, a printed wiring board using the cured prepreg and electronic parts using the cured prepreg.

### RELATED ART

In recent years, signal areas of information communication devices such as PHS, portable phones, etc and CPU clock time of computers have become GHz zones. The higher the frequency of the electric signals, the larger the dielectric loss and conductor loss become. The transmission loss attenuates the electric signals thereby to lessen reliability of the electric signals. Accordingly, in the field of printed wiring boards that deal with high frequency signals it is necessary to employ a device for suppressing an increase in the dielectric loss, conductor loss and radiation loss.

The dielectric loss is proportional to a square root of a specific dielectric constant of an insulating material constituting the wirings and a product of a dielectric tangent and a frequency of signals used. Therefore, it may be possible to control the dielectric loss by choosing insulating materials with small dielectric constant and small dielectric tangent.

Typical insulating materials with small dielectric constant and small dielectric tangent are explained as follows.

Fluorinated resins such as polytetrafluoroethylene (PTFE) exhibit low dielectric constant and low dielectric tangent; PTFE has been used for substrate materials that deal with high frequency signals. On the other hand, there have been investigated various non-fluorinated insulating materials that are easy in handling because of low molding temperature and curing temperature, have low dielectric constant and low dielectric tangent and are easily made into varnish with an organic solvent.

For example, patent document No. 1 discloses diene group polymers such as polybutadiene are impregnated into a substrate such as glass cloth and is cured with a peroxide.

Patent document No. 2 discloses epoxy groups are introduced into norbornene adduct polymerization type polymers to impart curability of cyclic polyolefins.

Patent document No. 3 discloses a composition comprising cyanate ester, diene polymer and epoxyresin being heated to make it B stage.

Patent document No. 4 discloses a modified resin composition comprising polyphenylene oxide, diene group polymer and triallyl isocyanate.

Patent document No. 5 discloses resin compositions comprising arylated polyphenylene ether and triallyl isocyanate, etc.

Patent document No. 6 discloses a composition comprising polyether imide, styrene and divinyl benzene or divinyl naphthalene, the members being alloyed.

Patent document No. 7 discloses a resin composition comprising bis(vinylbenzyl)ether, which is synthesized by Williamson reaction of a dihydroxy compound and chloromethyl styrene and novolac phenol resin.

Patent document No. 8 discloses a resin composition wherein polyfunctional polystyrene compound of an entire hydrocarbon main chain is used as a cross linking agent.

On the other hand, in parallel with improvement of dielectric characteristics of the resin materials, there have been investigated substrate materials with low dielectric constant and low dielectric tangent into which resin compositions are impregnated. For example, patent document No. 9 discloses PTFE fiber, cloth for printed wiring board, which is composed of PTFE fiber and polyamide fiber, D glass cloth, and cloth composed of D glass fiber and polyamide fiber.

Patent document No. 10 discloses cloth composed of PTFE fiber and E glass fiber or D glass fiber.

Patent document No. 11 discloses non-woven cloth made of polypropylene (PP) fiber.

Patent document No. 12 discloses non-woven cloth made of cyclic polyolefin fiber.

Patent document No. 13 discloses NE glass cloth wherein compositions of silicon dioxide, aluminum oxide, boron oxide, etc are adjusted.

Patent document No. 14 discloses quartz glass cloth.

Patent document No. 15 discloses non-woven quartz glass fiber.

Patent document No. 16 discloses cloth composed of quartz glass fiber and glass fiber other than the quartz glass fiber.

Patent document No. 17 discloses cloth composed of hollow quartz glass fiber.

Among the above substrate materials, quartz glass fiber cloth and non-woven cloth may have the smallest dielectric constant and dielectric tangent.

There have been investigated various combinations of the low dielectric tangent substrate material and the low dielectric tangent resin materials; patent document No. 18 discloses a resin whose base is polyfunctional styrene compound and the different substrate material with low dielectric constant and low dielectric tangent.

Patent document No. 19 discloses a resin composition containing polyfunctional styrene compound as a cross linking agent, the composition being impregnated into quartz glass cloth to produce prepreg, wherein cured prepreg exhibits dielectric tangent at 10 GHz is as low as 0.0009.

However, it has been pointed out that quartz glass with excellent dielectric properties is hard and its drilling workability is worse than other substrate materials and is expensive.

Patent document No. 1; JP S58-021925 B

Patent document No. 2; JP H10-158337

Patent document No. 3; JP H11-124491

Patent document No. 4; JP H09-118759

Patent document No. 5; JP H09-246429

Patent document No. 6; JP H05-156159

Patent document No. 7; JP H05-078552

Patent document No. 8; JP 2002-249531

Patent document No. 9; JP S62-045750

Patent document No. 10; JP H02-061131

Patent document No. 11; JP H07-268756

Patent document No. 12; JP 2006-299153

Patent document No. 13; JP 09-074255

Patent document No. 14; JP 2004-099376

Patent document No. 15; JP 2004-353132

Patent document No. 16; JP 2005-336695

Patent document No. 17; JP 2006-027960

Patent document No. 18; JP 2003-012710

Patent document No. 19; JP 2005-089691

Patent document No. 20; JP 2004-087639

Patent document No. 21; JP 2003-160662

Although the conventional woven cloth or non-woven cloth of quartz glass fiber has small dielectric tangent and excellent electrical properties, it has such problem as difficult working and high price. In addition, cloths using D glass fiber and NE glass fiber have larger dielectric tangent than the quartz glass fiber. Cloths using PTFE fiber and glass fiber or polyamide fiber have a larger dielectric tangent than the quartz glass fiber. Because of poor mutual solubility between the PTFE fiber and impregnating resins, separation at the interface between the fiber and the resin tends to occur. This phenomenon may lead to an increase in dielectric tangent due to absorption of humidity and lowering of solder heat resistance.

Further, PTFE substrate may cause a problem of hazard gas, such as hydrogen fluoride, etc, which may be generated by combustion disposal of the waste material. Non-woven cloth made of PP fiber, cyclic polyolefin fiber, etc have problems in view of thermal expansion coefficient and mechanical strength.

### SUMMARY OF THE INVENTION

Accordingly, it is an object of the present invention to provide a prepreg comprising a substrate with a small dielectric tangent, lightweight, high mechanical strength and low thermal expansion coefficient, and the prepreg impregnated with a resin composition which has a small dielectric tangent after being cured. Further, the present invention provides a substrate material or film material with excellent workability and small dielectric tangent that uses the prepreg, and electronic parts for high frequency use that use the prepreg as an insulating material.

The present invention provides a prepreg, which is thermosettable and comprises a thermosetting resin composition A, a cured resin of the thermosetting resin composition exhibiting a dielectric tangent of 0.005 or less under 1 GHz or more, and a substrate B into which the resin A is impregnated, wherein the substrate B comprises polyolefin fiber C and a fiber D, which has a tensile strength higher than that of the polyolefin fiber C and a thermal expansion coefficient smaller than that of the fiber C, and wherein the substrate is a woven cloth and has a solubility rate into a hydrocarbon organic solvent is less than 5 wt %. The present invention also provides, among other things, a multi layer wiring board.

According to embodiments of the present invention, by employing a prepreg comprising a composite substrate composed of polyolefin fiber and a high mechanical strength fiber being impregnated with thermosettable, low dielectric tangent resin, printed wiring boards, multi layer printed wiring boars, flexible printed wiring boards with lightweight, excellent workability, and small dielectric tangent can be produced. The wiring printed boards of the embodiments of the present invention are particularly suitable for insulating material of high frequency use electronic devices.

### BRIEF DESCRIPTION OF DRAWING

FIG. 1 shows a flow chart for producing an antenna built-in wiring substrate.

### REFERENCE NUMERALS

1; copper foil, 2; laminated prepreg, 3; photoresist antenna pattern, 4; photoresist through-hole pattern, 5; antenna pattern, 6; through-hole pattern, 7; wiring pattern, 8; through-hole, 9; silver paste, 10; ground

A first embodiment of the present invention is: (1) A prepreg, which is thermosettable and comprises a thermosetting resin composition A, a cured resin of the thermosetting resin composition exhibiting a dielectric tangent of 0.005 or less under 1 GHz or more, and a substrate B into which the resin A is impregnated, wherein the substrate B comprises polyolefin fiber C and a fiber D, which has a tensile strength higher than that of the polyolefin fiber C and a thermal expansion coefficient smaller than that of the fiber C, and wherein the substrate is a woven cloth and has a solubility rate into a hydrocarbon organic solvent is less than 5 wt %. It is needless to say that the prepreg is made a B stage as same as the conventional prepregs.

In general, the polyolefin fiber has the low dielectric tangent as do the silicon oxide fiber and PTFE fiber, and its density is smaller among the resin materials. However, since the polyolefin fiber itself has low tensile strength and poor heat resistance, there were fears about deformation or breakage due to stress of impregnation and heating at the time of drying. Further, since the thermal expansion coefficient of the polyolefin is large, it does not contribute to lowering of the thermal expansion coefficient. The present invention improve the above problem by utilizing a combination of the polyolefin and fiber D with a high strength and low thermal expansion coefficient.

The dielectric tangent of the composite substrate B comprising the polyolefin fiber and the high strength fiber D is smaller than that of cloths made of D glass fiber or NE glass fiber and workability of the composite substrate B is better than that of cloth made of quartz glass fiber. Further, the bonding property of the composite substrate B with the impregnating resin is better than that of a substrate made of PTFE fiber, and it has a smaller load on environment than other materials do.

Although a content of the polyolefin in the composite substrate may be chosen arbitrarily, a preferable range of the content is such that the lowering effect of the dielectric tangent by the polyolefin fiber C and reinforcing effect of the high strength fiber D are balanced; in other words, a content of the polyolefin fiber is 40 to 60 wt %.

The substrate B used in the present invention should have a sufficient resistance to organic solvents, and a preferable amount of soluble components in the substrate B should be less than 5 Wt %, and more preferably, less than 1 wt %. The small amount of the soluble components in the substrate B prevents deformation and breakage due to solution or swelling of the substrate B at the time that a resin composition A is made into a varnish state and is impregnated into the substrate B. The small amount of soluble components also prevents a change of the composition of the resin composition A by the dissolved components from the substrate B entering the varnish.

The resin composition, a cured resin of which exhibits the dielectric tangent of 0.005 or less, has a small number of polar groups in its molecular structure. Organic solvents for preparing such the varnishes should be hydrocarbon solvents of small number of polar groups; typical examples of the organic solvents are toluene, xylene, cyclohexane, etc. Accordingly, the substrate B should be sufficiently resistive to the organic solvents.

In the prepreg (1), a substrate B of cloth, which is prepared from yarn comprising the polyolefin fiber C and high strength fiber D is preferable. By using the composite yarn of the polyolefin fiber C and the high strength fiber D, deformation of the substrate due to difference in tensile strength, thermal expansion and elongation between the fibers can be suppressed, and fluctuation of dielectric constant and dielectric tangent in a plane by difference in the constituting materials can be suppressed.

Another embodiment of the present invention is: (2) A prepreg, which is curable and comprises a resin composition A, a cured resin of the resin composition exhibiting a dielectric tangent of 0.005 or less under 1 GHz or more, and a substrate B into which the resin composition A is impregnated, wherein the substrate B is non-woven cloth and comprises polyolefin fiber C and a fiber D, which has a tensile strength higher than that of the polyolefin fiber C and a thermal expansion coefficient smaller than that of the fiber C, and wherein the substrate is a woven cloth and has a solubility rate into a hydrocarbon organic solvent is less than 5 wt %.

By making a composite substrate comprising the polyolefin fiber C and high strength fiber D, lowering of dielectric tangent and high strength of the substrate B and thermal expansion coefficient are balanced. By using the non-woven cloth, it is possible to produce more flexible cured prepregs (hereinafter referred to as a laminate) than in case of the woven cloth. The prepreg using the non-woven cloth is particularly suitable for flexible printed wiring board.

Although a content of the polyolefin fiber C in the non-woven cloth may be chosen arbitrarily, a preferable amount of the polyolefin fiber is 40 to 60 wt %, in which lowering effect of dielectric tangent by the polyolefin and reinforcing effect are well balanced.

In the prepreg (2), it is preferable that the polyolefin fiber and the high strength fiber D are fused each other so that the handling and workability of the substrate are improved. That is, in handling of the substrate B of non-woven cloth and in impregnating the resin composition A into the substrate B, the raveling of the fibers is avoided. In general, non-woven cloths have a small restricting force between fibers by twisting, compared with woven cloths, and they have bulky structure. When the bulky non-woven cloths are used, an amount of impregnating resin becomes larger, which tends to lead to difficulty in controlling an amount of impregnation.

When fibers of the non-woven cloth is pressed to make a thickness of the cloth small, the content of the impregnating resin can be easily controlled. In the present invention, since the polyolefin fiber melts and performs as an adhesive, an adhesive such as epoxy resin, which has been used for bonding the fibers, is no longer needed. Accordingly, it is possible to avoid an increase in dielectric tangent caused by addition of the adhesive.

In the prepreg (1) or (2) the fiber C may be polyolefin fiber which contains at least one of polymer or copolymer of α-olefin compound. Examples of preferred polyolefin fiber C include polymers or copolymers of α-olefin compounds such as ethylene, propylene, butane-1, 4-methylpentene-1 or mixtures of the polymers or copolymers. α-Olefin compounds are preferable because of their small dielectric tangents. Particularly, polypropylene and ethylene-propylene copolymer are most preferable because they have excellent resistance to the organic solvents.

From the view-points of improvement of heat resistance of the substrate, introduction of polypropylene or polymethylpentene structure units is preferable to elevate softening point or melting temperature. Melting points of polypropylene and polymethylpentene are around 160° C. and around 230° C. The polyolefin fiber C employed in the present invention can control fusibility and heat resistance by adjusting a rate of polymers or a mixing rate.

In the prepreg (1) or (2) glass fiber as the fiber D, which is surface treated with silane coupling agents is preferable.

As the high strength fiber D in the present invention crystalline polymer fiber, various glass fibers, polyamide fiber, etc are chosen from the conventional fiber materials. If toughness of the laminate or printed wiring board is required, glass fibers are preferable. Combination of the polyolefin fiber C and glass fiber D improves mechanical strength of the substrate B thereby to suppress deformation and breakage thereof during steps of manufacturing the prepreg, as well as lowering the thermal expansion coefficient of printed wiring boards. As the glass fibers, known E glass, D glass, NE glass, etc can be used. By combining the glass fiber with the poly olefin fiber, the dielectric constant and dielectric tangent of the substrate can be lowered, compared with the polyolefin fiber alone.

Among the glass fibers, D glass fiber and NE glass fiber are preferable because of their dielectric properties. If a further lowered dielectric tangent is desired, quartz glass fiber may be used as discussed later. In using the glass fibers the surface of the fiber should preferably be treated with the silane coupling agents. As a result, the glass fiber and the resin composition A are chemically bonded at the time of curing the resin composition A so that separation between the resin and glass fiber at the interface can be prevented by improving the adhesion between the cured resin composition A and the glass fiber. Prevention of the interface separation is benefit to avoid an increase in dielectric tangent due to adsorbed water in the separated surface and lowering of heat resistance to soldering. Examples of silane coupling agents include γ-methacryloxypropyl dimethoxy silane, γ-methacryloxypropyl trimethoxy silane, γ-methacryloxypropyl trimethoxy silane, vinyltrimethoxy silane, vinyltriethoxy silane, vinyltris(β-methoxyethoxy) silane, p-stylyltrimethoxy silane, etc. Among them, vinyl group silane compounds are preferable because the treated surface is stable and they are chemically reactable with the resin composition A.

Further, in preparing the substrate B other coupling agents such as other silane coupling agents, titanium group coupling agents or aluminum group coupling agents to thereby introduce lubricating components to the surface of the glass fiber so that breakage of the glass fiber caused by friction between the fibers is prevented.

In the prepregs (1) and (2) the high strength fiber D should preferably be quart glass fiber. If this is used, reduction of the dielectric tangent is effectively done, which is caused by a particularly small dielectric constant of the quartz glass fiber. When the polyolefin fiber and the quartz glass fiber are combined. It is possible to lessen an amount of the quartz glass fiber to thereby alleviate reduction of workability of the prepreg.

In the prepregs (1) and (2) a fusion temperature (melting temperature) or glass transition temperature of the polyolefin fiber C should preferably be 130° C. or higher, and more preferably 160° C. or more so that deformation and breakage of the substrate B in coating the resin varnish and heating the substrate for drying can be suppressed.

In general, a drying temperature for the prepreg is approximately the same as that of a boiling temperature of a drying temperature for prepregs is set to be approximately equal to a boiling temperature of a solvent for making varnish. Even if it includes a heating step for accelerating B-stage of the prepreg, the temperature range is 100 to 150° C. Accordingly, it is possible to prevent deformation, breakage of woven cloth or non-woven cloth containing polyolefin fiber at the drying temperature for producing the prepreg.

In the prepreg (1) and (2), it is possible to employ the resin composition containing the polyfunctional styrene compound represented by the following general formula I. This composition reduces dielectric tangent of the cured resin composition; thus, the dielectric tangent of a laminate or printed wiring board can effectively be reduced. The fact that the polyfunctional styrene compounds represented by the general formula I give cured resin having small dielectric tangent was known as disclosed in Patent document no. 18, but there was a limit for lowering the dielectric tangent of printed wiring boards when conventional glass cloth were used.

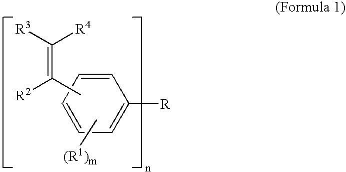

In the formula I R represents a hydrocarbon chain, R1s are hydrogen or hydrocarbon groups having a carbon number of 1 to 20, R1 being the same or different, R2, R3 and R4 are the same of different and are hydrogen or hydrocarbon groups having a carbon number of 1 to 6, m is an integer of 1-4, n is an integer of 2 or more, and a weight average molecular weight as a conversion of polystyrene is 1000 or less.

In the present invention by utilizing the substrate B composed with the polyolefin fiber and the high strength fiber D, it is possible to lower the dielectric tangent, keeping workability of the laminate and printed wiring boards. The resin composition containing the polyfunctional styrene compound having a molecular weight of 1000 or less, the prepreg using the resin composition is suitable for high frequency printed wiring boards, multi layer printed wiring boards, etc, though the properties may depend on an amount of rubber used. As applications of the printed boards, there are antenna substrates, high-speed servers, back plane, etc, such as rooters.

As examples of the polyfunctional styrene compounds, there are polyfunctional styrene compound disclosed in the patent document No. 20. The examples include 1,2-bis(p-vinylphenyl)ethane, 1,2-bis(m-biphenylphenyl)ethane, 1-(p-biphenyl)-2-(m-biphenylphenyl)ethane, bis(p-vinylphenyl)methane, bis(m-vinylphenyl)methane, p-vinylphenyl-m-vinylphenylmethane, 1,4-bis)p-vinylphenyl)benzene, 1,3-bis(m-vinylphenyl)benzene, 1-(p-vinylphenyl)hexane, 1,6-bis(m-vinylphenyl)hexane, 1-(p-vinylphenyl)-6-(m-vinylphenyl)hexane. The examples also include divinylbenzene polymers having vinyl groups at side chains.

When compounds are used singly or in combinations. When these compounds are used a cross-linking agents, the resin composition A can be cured without using the curing catalyst because of high activity of the styrene groups. Accordingly, the adverse affect by the curing catalysts, which may increase the dielectric tangent of the cured resin, is suppressed so that the prepreg is suitable as a cross linking agent for high frequency use insulating material.

The prepregs (1) and (2) should preferable be prepared from the resin composition A composed of a polybutadiene compound having a repeating unit represented by the following general formula 2 and a curing catalyst for accelerating the cure of the polybutadiene. The resin composition A provides a cured resin composition having a low dielectric tangent and an excellent flexibility.

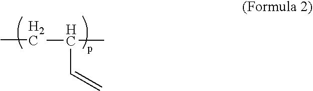

(In the formula, p is an integer of 2 or more.)

Preferable polybutadiene compounds are ones having a number average molecular weight 1,000 to 170,000 as a conversion of polystyrene in the GPC (Gel Permeation Chromatography) measurement, and a rate of 1,2 bonds is 90% or more. The molecular weight should be adjusted from the viewpoints of tack-free property and flowability. For example, polybutadiene having a molecular weight of 3,000 or less and polybutadiene having a molecular weight of 130,000 are mixed at a ratio of a range from 75/25 to 25/75 and if adhesion at room temperature is needed, the high molecular weight polybutadiene is 45 parts by weight or less; if the tack free property is needed, the high molecular weight polybutadiene is 50 parts by weight or more.

Curability of the polybutadiene compounds can be freely adjusted by additive amounts of the curing catalyst. Therefore, it is easy to give flexibility to cured prepregs i.e. laminates that utilize resin compositions A containing the polybutadiene as a cross linking agent. The prepregs are particularly suitable for printed wiring boards, multi printed wiring boards, especially flexible printed wiring boards.

As applications of flexible printed wiring boards that use high frequency signals, there are flexible printed wiring boards for connecting signal processing circuits and magnetic heads of large scaled storage device and liquid crystal displays.

Although a dielectric tangent of cured resin composition A containing polybutadiene as a cross linking agent tends to become large, compared with the cured resin composition A containing the polyfunctional styrene compound as the cross linking agent, it is possible to lower the dielectric tangent of laminates can be made small by using the substrate composed of the polyolefin fiber C and the high strength fiber D and by effects of additives, which will be described later.

In the prepregs mentioned above, as the curing catalyst a composite curing catalyst containing the resin composition A may contain a radical polymerization initiator having a half decay temperature for one minute is 80 to 140° C. in an amount of 3 to 10 parts by weight and a radical polymerization initiator having a half decay temperature of 170 to 230° C. in an amount of 5 to 15 parts by weight.

Curability of the polybutadiene depends on an amount of the curing catalyst, and the cured degree is adjusted by the amount of the catalyst. From this, it is possible to adjust a cross linking degree of the polybutadiene by adding a predetermined small amount of a curing catalyst for accelerating curing of the polybutadiene at low temperatures at the time of preparation of varnish of the resin composition A and drying step of the prepreg. Even when a large amount of polybutadiene of low molecular weight is used, it is possible to secure tack-free property of the prepreg by the above technique. Use of the low molecular weight polybutadiene is preferable from the viewpoint of low viscosity of varnish and good handling.

As examples of a half decay temperature in one minute at 80 to 140° C., there are isobutyrylperoxide, α,α′-bis(neodecanoylperoxy)diisopropylbenzene, cumylperoxy neodecanoate, di-n-propylperoxy dicarbonate, 1,1,3,3-tetramethylbutylperoxy neodecanoate, diisopropylperoxy dicarbonate, 1-cyclohexyl-1-methylperoxyneodecanoate, di-2-ethoxyethylperoxydicarbonate, di(2-ethylhexylperoxy) dicarbonate, t-hexylperoxy neodecanoate, dimethoxybutylperoxy didecanate, di(3-methyl-3-methoxybutylperoxy)dicarbonate, t-butylperoxy neodecanoate, t-hexylperoxy pivaltate, t-butylperoxy pivalate, 3,5,5-trimethylhexanoylperoxide, octanoylperoxide, 1,1,3,3-tetramethylbutylperoxy-2-ethylhexanoate, 2,5-dimethyl-2,5-di(2-ethylhexanoylperoxy)hexane, 1-cyclohexyl-1-methylethylperoxy-2-ethylhexanoate, t-hexylperoxy-2-ethylhexanoate, t-butylperoxy-2-ethylenehexanoate, m-toluoylperoxide, t-butylperoxy isobutylate.

The curing catalysts having a half decay temperature in one minute at 170 to 230° C. has a function to curing degree of the laminates. Accordingly, it is possible to give resistance to solvents, heat resistance and low thermal expansion to the cured resin composition A containing the polybutadiene as the cross linking agent.

Examples of the curing catalysts having a half decay temperature in one minute at 170 to 230° C., there are α,α′-bis(t-butylperoxy)diisopropylbenzene, dicumylperoxide, 2,5-dimethyl-2,5-di(t-butylperoxy)hexane, t-butylcumylperoxide, di-t-butylperoxide, 2,5-dimethyl 2,5-di(t-butylperoxy)hexyne-3, and t-butyltrimethylsilylperoxide.

In the prepregs (1) and (2) the resin composition A may contain a bismaleimide compound, which is represented by the following general formula.

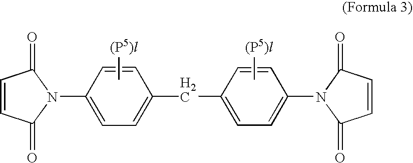

(In the formula R⁵ may be the same or different, each being a hydrocarbon group containing 1 to 4 carbon atoms, 1 being an integer of 1 to 4.)

A varnish of the resin composition containing the maleimide compound as a cross linking agent has a remarkably lower viscosity than varnishes containing the polyfunctional styrene compound or polybutadiene compound as a cross linking agent. Further, it has been elucidated that a cured resin of the resin composition containing the bismaleimide compound represented by the general formula 3 exhibited low dielectric tangent for bismaleimide compound, though the dielectric tangent is not better than that of the resin composition containing the polyfunctional styrene compound. This is because steric hindrance due to alkyl groups (R5) contained in the molecule suppresses the rotating movement in the molecule.

As examples of the bismaleimide compounds having the specified structure, bis(3-methyl-4-maleimidephenyl)methane, bis(3,5-dimethyl-4-maleimidephenyl)methane, bis(3-ethyl-4-maleimidephenyl)methane, bis(3-ethyl-5-methyl-4-maleimidephenyl)methane, bis-(3-n-butyl-4-maleimidephenyl)methane, etc. Varnishes having high concentrations and low viscosities are easy for controlling thickness of the coating and good film forming property, which bring about high efficiency of coating work. Since they have low viscosities, foreign substances may be easily removed by filtering and filtering work can be done effectively.

In the above described prepregs the resin composition A may contain hydrogenated styrene-butadiene copolymer and at least one co-cross linking agent selected from the group consisting of curable polyphenylene oxide, trimellitic acid triallylate and pyromellitic acid tetraallylate. Such the resin composition A gives a cured article having a reduced dielectric tangent and flexibility by adjusting of cross-linking density and controlled adhesion. The hydrogenated styrene-butadiene copolymer gives the resin composition A flexibility, tack-free property and reduced dielectric tangent because of entirely hydrocarbon chain.

The addition of the copolymer contributes to improvement of adhesion between the conductor layer and the cured prepreg. As examples of the hydrogenated styrene-butadiene copolymers, there are H1031, H1041, H1043, H1051, H1052 (the products by Asahi Chemicals Corp.), etc. In case of the resin composition A containing the polyfunctional styrene compound and the specified bismaleimide compound, it is preferable to uses a styrene-butadiene copolymer containing a styrene residual rate of 30 to 70 wt %. As a result, a phase separation is not observed when the copolymer is used with a curable polyphenylene oxide and moreover the resin composition gives high glass transition temperature.

In case of resin composition A which contains polybutadiene as a cross linking agent, it is preferable to use a styrene-butadiene copolymer containing 10 to 30 wt % of styrene residual rate. As a result, the phase separation is prevented and a high glass transition temperature is given to the cured resin.

The curable polyphenylene oxide suppresses an increase in a cross linking density, promotes curing of the resin composition and prevents solution out of hydrogenated styrene-butadiene copolymer, which has no reactivity, and improves tack-free property. Further, since the increase in the cross linking density is suppressed, adhesion between the conductor layer and the cured prepreg is improved.

Examples of curable polyphenylene oxides include maleic acid anhydride modified polyphenylene oxides and aryl modified polyphenylene oxides disclosed in Japanese Patent Document No. 5, and thermosettable polyphenylene oxides having relatively small molecular weight disclosed in Japanese Patent Document No. 21.

Trimellitic acid triallylate and pyromellitic acid give increased cross linking density of cured resin of the resin composition A tetraallylate; particularly, modulus of elasticity at high temperature of cured resin of a resin composition A containing polybutadiene is improved. Accordingly, the above compounds are preferably added to the resin composition A containing the polybutadiene as a cross linking agent.

In the above described prepregs the resin composition A should preferably contain a non-flammable agent represented by the formulae 4 or 5 and silicon oxide filler, both having an average particle size of 0.2 to 3.0 μm. As a result, the dielectric tangent of the cured resin is further reduced and non-flammability and low thermal expansion are achieved. Since the non-flammable agents shown by the formulae 4 and 5 and silicon dioxide filler exhibit low dielectric tangents, it was particularly effective for reducing dielectric tangent of cures resins of resin compositions A containing the specified maleimide compounds and polybutadiene as cross linking agents.

### (Formulae 4 and 5)

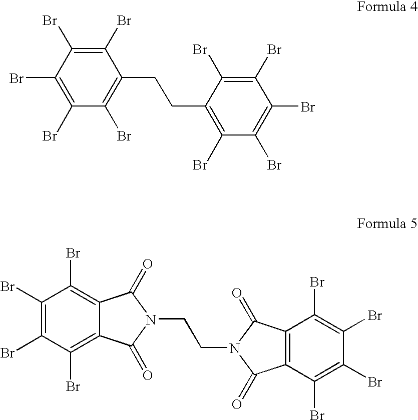

By using the non-flammable agents and silicon oxide filler having an average particle size of 0.2 to 3.0 μm, precipitation of the non-flammable agent and the filler in the resin composition A is prevented when the resin composition A is stored in a form of varnish. Though it may depend on viscosity of the varnishes, it is possible to prevent the precipitation of the non-flammable agent and silicon oxide filler having the above-mentioned average particle size in varnishes of 0.1 to 1.0 Ps.

In the prepregs the resin composition A may preferably contain coupling agents. As a result, peeling-off of silicon oxide filler from the resin phase is prevented and absorption of humidity at the peeled interface is prevented so that an increase in the dielectric tangent is avoided. Preferable examples of coupling agents include γ-methaclyoxypropyldimethoxy silane, γ-methacryloxypropyldimethoxy silane, vinyltrimethoxy silane, vinyltriethoxy silane, γ-methacryloxypropyltriethoxy silane, vinyl tris(β-methoxyethoxy)silane, p-styryltrimethoxy silane, etc.

In the above-described prepregs the coupling agents should preferably be carried by the silicon oxide filler. As a result, it is possible to remove an excess amount of coupling agent by rinsing so that an increase in the dielectric tangent due to the excess amount of the coupling agents is suppressed. Since the coupling agents have polar groups in the molecules, addition of excess amount of the coupling agents leads to an increase in the dielectric tangent. Accordingly, the amount of the coupling agents should be as small as possible as far as the reduction of the dielectric tangent is observed. As a method for lowering the amount of the coupling agents, a solution of the coupling agent of a concentration of about 1 wt % is prepared by using methanol, ethanol, propanol, etc and silicon oxide filler is put into the solution. The solution is mixed for about 2 hours with a ball mill to carry out surface treatment. Then, the silicon oxide filler is separated by filtering from the solution, and rinsed with alcohol to remove excess coupling agent to obtain surface treated silicon oxide filler.

As an advantage of combination of the polyfunctional styrene compound whose main chain is entire hydrocarbon chain, polybutadiene or styrene-butadiene copolymer with the substrate B made of polyolefin fiber C and high strength fiber D for the resin composition A, there is improvement in solder resistance at the time of humidity adsorption, as well as reduction in dielectric tangent. It is presumed that adhesion between the substrate B and the resin composition A is increased by mutual dissolution between the polyolefin fiber C and polyfunctional styrene compound, polybutadiene or styrene-butadiene copolymer caused by heating-pressurizing at a laminate manufacturing step. As a result, the solder resistance is improved, compared with the cloth using only glass fiber.

A mixing rate of components for the resin composition A can be adjusted in accordance with characteristics required for prepregs, printed wiring boards, multi printed wiring boards, etc. Generally, the components are used in the ranges set forth below.

A mixing rate of a cross linking agent of the resin compositions A containing polyfunctional styrene compound or specified bismaleimide compound as a cross linking agent and styrene-butadiene copolymer and curable polyphenylene oxide as a co-cross linking agent poly is as follows.

A preferable mixing rate of the cross linking agent/curable polyphenylene ether is 10/90 to 50/50 by weight.

A mixing rate of the total amount of the cross linking agents to the styrene-butadiene copolymer is 10 to 50 parts by weight per 100 parts by weight of the total amount of the cross linking agent plus curable polyphenylene ether, more preferably, 10 to 30 parts by weight of styrene-butadiene copolymer per the total amount of the cross linking agent and curable polyphenylene ether. In the above mixing rate, it is desirable to adjust solvent resistance, mechanical strength, film forming property, adhesion to conductor foil and glass cloth of cured resin.

Mixing rates of the nonflammable agent and silicon oxide filler are as follows:

The nonflammable agent is 10 to 150 parts by weight and the silicon oxide filler is 10 to 150 parts by weight respectively per 100 parts by weight of the total amount of the cross linking agent, curable polyphenylene oxide and styrene-butadiene copolymer, in accordance with properties desired for nonflammability, dielectric tangent and thermal expansion, etc.

A preferable polybutadiene-based composition of the resin composition A is styrene-butadiene copolymer in a range of 10 to 30 parts by weight, curable polyphenylene oxide in a range of 10 to 30 parts by weight, curing catalyst in a range of 1 to 20 parts by weight, silicon oxide filler in a range of 80 to 150 parts by weight, nonflammable agent in a range of 50 to 150 parts by weight, and trimellitic acid triallyl or pyromellitic acid tetra-allyl in a range of 5 to 20 pats by weight per 100 parts by weight of polybutadiene. The composition is adjusted in accordance with desired nonflammability, dielectric tangent, thermal expansion coefficient, etc.

In the case where the coupling agent is added to the resin composition, a preferable amount thereof is 0.5 to 1.5 parts by weight per 100 parts by weight of silicon oxide filler.

It is possible to add additives to the resin composition in ranges that greatly deteriorate the dielectric tangent. Examples of the additives are third cross linking agents such as various maleimide resins, epoxyresins, cyanate ester resins, (meta) acrylate resins, etc, and high polymers with low dielectric tangent such as polyphenylene oxide, cyclo-olefin polymers, anti-oxidation agents, coloring agents, polymerization inhibitors, hollow fillers, etc.

Solvents for making varnishes should preferably have a boiling point of 140° C. or lower, more preferable 110° C. or lower; examples thereof are toluene, cyclohexane, etc. The solvents are used singly or in combination. The solvents may contain polar solvents for use in coupling treatment such as methyl ethyl ketone, methanol, etc.

Preferable conditions for drying prepregs prepared by impregnating the resin composition into the substrate B are 80 to 150° C., more preferably 80 to 110° C. for a drying time of 10 to 90 minutes.

According to the present invention, it is possible to manufacture laminates having conductor layers on one or both faces of the cured prepregs. As a result, it is possible to produce various printed wiring boards with low dielectric tangent and low thermal expansion coefficient.

Further, according to the present invention, it is possible to provide printed wiring boards with low dielectric tangent insulating layer to which printed wiring work is done. The printed wiring boards are particularly suitable for high frequency use printed wiring boards and antenna substrates because of the low dielectric tangent loss to high frequency signals.

By laminating and bonding the printed wiring boards with the prepregs and connecting between the printed wiring boards with known methods, multi printed wiring boards with excellent transmission performance of high frequency are produced.

Because of the low dielectric tangent of the electronic devices having the high frequency circuits whose insulating layers are made of the cured prepregs, it is possible to utilize a higher frequency band wave so that high speed communication can be realized by wide band communication and an increase in high density signals. Examples of the electronic devices are high frequency antenna circuits, high-speed servers, backplanes such as rooters, high speed communication use flexible substrates for hard discs, liquid display devices, etc.

In the following the present invention will be explained by referring to examples and comparative examples; however, the scope of the present invention is not limited thereto. Table 1 shows compositions of the examples 1 to 3 and comparative example 1, Table 2-1 and Table 2-2 show characteristics of cured products of examples 4 to 13 and comparative examples 2 and 3 and Table 3 shows characteristics of laminates of examples 14 to 17.

### Synthesis of 1,2-bis(biphenyl)ethane (BVPE)

5.36 grams (220 mmol) of granular magnesium (manufactured by Kanto Chemical Co. Inc.) for Grignard reagent was put into a three-necked flask of 500 ml; a titrating funnel, a septum cap and a tube for introducing nitrogen were provided to the flask. Under nitrogen stream, while stirring the magnesium granules with a stirrer the reactant system was subjected to dehydration by drying with a drier. 300 ml of tetrahydrofuran was picked into a syringe and was introduced through the septum cap into the solution of the reaction system. After the solution was cooled to −5° C., 30.5 grams (200 ml) of vinylbenzyl chloride (manufactured by Tokyo Kasei Kogyo Co., Ltd.) was titrated for about 4 hours through the titrating funnel.

After the titration was completed, stirring was continued for 20 hours at 0° C. After the reaction was completed, the reaction solution was filtered to remove the residual magnesium and the solution was concentrated with an evaporator. The concentrated solution was diluted with hexane and rinsed once with a 3.6% hydrochloric acid solution and three times with pure water; then the solution was dehydrated with magnesium sulfate.

The dehydrated solution was purified by passing through a short column of silica gel (Wakol gel C 300 manufactured by Wako Pure Chemical Industries, Ltd.)/hexane, and the purified product was vacuum-dried to obtain desired BVPE. The resulting BVPE was a mixture of 1,2-bis(p-vinylphenyl) ethane (PP body, solid), 1,2-bis(m-vinylphenyl)ethane (m-m body, liquid), and 1-(p-vinylphenyl)-2-(m-vinylphenyl)ethane (m-p body, liquid) at a yielding rate of 90%.

A structure of the product was investigated by ¹H-NMR and it was elucidated that the resulting data agreed to that of documents. (6H-vinyl: α-2H(6.7), β-4H(5.7, 5.2); 8H-aromatic (7.1-7.4); 4H-methylene (2.9)). The resulting BVPE was used as a cross linking agent.

(Bismaleimide)

BMI-5100 (manufactured by Daiwa Kasei Industry Co., Ltd.), which is bis(3-ethyl-5-methyl-4-maleimidephenyl)methane.

(Polybutadiene)

RB810 (manufactured by JSR Co.), which has an average molecular weight of 300 as a styrene conversion number and has 1,2-bonds of 90% or more.

(Styrene-Butadiene Copolymer)

Toughtec H1031 (Trade name of Asahi Chemicals Co.), which contains 30% by weight of styrene.

Toughtec H1043 (Trade name of Asahi Chemicals Co.), which contains 67% by weight of styrene.

(Curable Polyphenylene Oxide)

OPE2St (manufactured by Mitsubishi Gas Chemical Co.), which has an average molecular weight of 2200 as a styrene conversion number and styrene groups at both ends thereof.

(Trimellitic Acid Triallyl)

TRIAM-705 (manufactured by Wako Junyaku Co.)

(Curing Catalyst)

2,5-dimethyl-2,5-di(t-butylperoxy)hexine-3 (abbreviated as 25B) (manufactured by NOF Corporation.), which has a half decay temperature in one minute of about 196° C., and a purity of 90% or more.

Benzoyl peroxide abbreviated as BPO (manufactured by NOF Corporation.), which has a half decay temperature in one minute of about 130° C. and a purity of 75%.

(Nonflammable Agent)

SAYTEX8010 (manufactured by Albemarle Japan Corp.), which is 1,2-bis(pentabromophenyl)ethane and has an average particle size of 5 μm and 5.5 μm.

(Silicon Oxide Filler)

Admafine (manufactured by Admatechs Co.), which has an average particle size of 0.5 μm.

(Coupling Agent)

KBM-503 (manufactured by Shin-Etsu Chemical Co., Ltd.), which is γ-methacyloxy propyldimethoxy silane.

(Other Additives)

YPX100D (manufactured by Mitsubishi Gas Chemical Co.), which is high molecular weight polyphenylene oxide

(Copper Foil)

AMFN-1/2Oz (manufactured by Nikko Materials Co., Ltd.), which is treated with a coupling agent, and has a thickness of 18μ and Rz of about 2.1 μm.

(Woven Cloth of Quartz Glass Fiber/Polyolefin Fiber)

Cloth No. 1 (manufactured by Shin-Etsu Chemical Co., Ltd.), which is composed of quartz glass fiber and polypropylene fiber and contains polyolefin of 43% by weight.

Cloth No. 2 (manufactured by Shin-Etsu Chemical Co., Ltd.), which is composed of quartz glass fiber and polypropylene fiber and contains polyolefin of 43% by weight.

Cloth No. 3 (manufactured by Shin-Etsu Chemical Co., Ltd.), which is composed of mixed yarn of quartz glass fiber and polypropylene fiber and contains polyolefin of 43% by weight.

Cloth No. 4, which is glass cloth.

(Non-Woven Cloth of Quartz Glass Fiber/Polyethylene Fiber)

Non-woven cloth No. 1 (manufactured by Shin-Etsu Chemical Co., Ltd.), wherein the polyethylene fiber has a melting point of 100° C. and a content of polyolefin fiber is 50% by weight, and the cloth was treated with melt-bonding.

Non-woven cloth No. 2 (manufactured by Shin-Etsu Chemical Co., Ltd.), which is composed of quart glass and polyethylene-polypropylene fiber and wherein the polyethylene-polypropylene fiber has a melting point of 130° C. and a content of polyolefin fiber is 50% by weight, and the cloth was treated with melt-bonding.

Non-woven cloth No. 3 (manufactured by Shin-Etsu Chemical Co., Ltd.), which is composed of quartz glass fiber and polypropylene fiber, and wherein the polypropylene fiber has a melting point of 160° C. and a content of polyolefin fiber is 50% by weight, and the cloth was treated with melt-bonding.

Non-woven cloth No. 4 (manufactured by Shin-Etsu Chemical Co., Ltd.), which is composed only of quartz glass, and the cloth was not treated with melt-bonding.

(Method of Preparing Varnish)

A predetermined amount of coupling agents and filler were mixed in a methyl-ethyl ketone solution with a ball mill for 2 hours to thereby treat the filler with the coupling agent. Then, predetermined amounts of resin materials, nonflammable agent, curing catalyst and toluene were added to the filler and the mixture was mixed with about 8 hours until the resin materials are completely dissolved therein to obtain a varnish. A concentration of the varnish was 40 to 45% by weight.

(Method of Preparing a Cured Resin (Resin Plate))

Varnishes of examples 1-11, 14-17 were coated on PET film and dried at room temperature for one night and at 100° C. for 10 minutes, and the coatings were peeled off. The peeled off films each was placed in a spacer having a thickness of 1.0 mm. The films were cured under pressure and heating by a vacuum press.

Varnishes of examples 12 and 13 were coated on PET film and the coating were dried at room temperature for one night and at 140° C. for 30 minutes in nitrogen gas stream. The coatings were peeled off and placed in a spacer having a thickness of 1.0 mm. The films were cured under pressure and heating by a vacuum press. Curing conditions are such that a pressure was increased to 2 MPa from room temperature and the temperature was elevated at a constant rate (6° C./minute) until 230° C. at which the films were heated for 60 minutes to cure the films.

(Method of Preparing Prepregs)

After the varnishes were impregnated into the woven cloth and non-woven cloth, the cloths were lifted up at a constant speed and were dried to produce prepregs. The drying conditions of the cloths of examples 1-11, 14-17 were 100° C./10 minutes and of examples 12 and 12 were 100° C./10 minutes and 140° C./10 minutes in nitrogen gas stream.

(Method of Preparing Copper Clad Laminate)

Four prepregs prepared in the above methods were laminated and the laminated prepregs were sandwiched by copper foils. The sandwiched laminates were cured under pressure and heating by a vacuum press. The curing conditions were such that pressure was increased to 2 MPa from room temperature and temperature was elevated at a constant rate (6° C./minute) to 230° C. at which the laminates were heated for 60 minutes.

(Measurement of Specific Dielectric Constant and Dielectric Tangent)

The specific dielectric constant and dielectric tangent of the laminates were measured by a cavity resonator method that uses 8722ES model Network Analyzer (manufactured by Agilent Technologies Co.) at values of 10 GHz. The cavity resonator was a product by Kantoh Electronic Application and Development Inc. The samples were prepared from the copper clad laminates by etching copper and cut into pieces of 2.0×80 mm. The samples were prepared by cutting the resin plates into 1.0×80 mm.

(Solder Heat Resistant Test)

Copper foil was removed by etching and the samples were cut into 20×20 mm pieces. After the samples were dried at 105° C. for one hour, the samples were immersed in a solder bath of 260° C. for 20 seconds. Thereafter, presence of separation among resin of the prepregs was investigated. The solder heat resistance test after humidity absorption was conducted in such a manner that copper foil of the copper clad laminates was removed by etching and were cut into 20×20 mm pieces. The sample pieces were retained at 120° C. in saturated steam for 20 hours; then the pieces were immersed in 260° C. solder bath for 20 seconds to thereby investigate occurrence of peeling-off.

(Modulus of Elasticity at High Temperature)

Modulus of elasticity of the sample pieces at 288° C. was measured using DVA-200 model viscoelasticity measuring device manufactured by IT Measurement and Control Co. Sample pieces were 1.5×30×0.5 mm cur resin plates. A distance between fulcrums was 20 mm, a rate of temperature elevation was 5° C./minute and a measurement frequency was 10 Hz.

(Storage Stability of Varnish)

8 mL of the resin composition varnishes were charged in sample tubes of 18 mm diameter and 40 mm high. After keeping them for 24 hours, a thickness (mm) of precipitate as a parameter for storage stability was measured.

TABLE 1

| Components | | Example 1 | Example 2 | Example 3 | Comp. Ex. 1 |
|---|---|---|---|---|---|
| Polyfunctional styrene comp. | BVPE | 50 | 50 | 50 | 50 |
| Styrene-butadiene | H1043 | 43 | 43 | 43 | 43 |
| Styrene-butadiene | H1031 | 0 | 0 | 0 | 0 |
| Other additives | YPX100D | 61 | 61 | 61 | 61 |
| Cross linking agent | TRIAM-705 | 50 | 50 | 50 | 50 |
| Co-Cross linking agent | OPE2St | 0 | 0 | 0 | 0 |
| Nonflammable agent | SAYTEX8010 | 23 | 23 | 23 | 23 |
| Filler | Admafine | 97 | 97 | 97 | 97 |
| Coupling agent | KBM503 | 0.9 | 0.9 | 0.9 | 0.9 |
| Substrate | | No | Cloth No. 3 | Nonwoven | Glass cloth |
| | | | | cloth | No. 4 (E |
| | | | | | glass) |
| Resin content | Wt % | 100 | 52 | 52 | 49 |
| Dielectric constant | 10 GHz | 2.6 | 2.6 | 2.4 | 3.8 |
| Dielectric tangent | 10 GHz | 0.0012 | 0.0007 | 0.0005 | 0.0045 |
| Solder heat resistance | 260° C. | — | No | No peeling | No |
| | | | Peeling-off | off | Peeling off |
| Solder heat resistance after | 260° C. | — | No peeling | No peeling | No peeling |
| humid-absorption | | | off | off | off |
| Modulus of elasticity at 288° C. | Pa | — | — | — | — |

TABLE 2-1

| | | Example 4 | Example 5 | Example 6 | Example 6 | Example 8 | Comp. Ex. 2 |
|---|---|---|---|---|---|---|---|
| Polybutadiene | B3000 | 75 | 75 | 75 | 75 | 75 | 75 |
| Polybutadiene | RB800 | 25 | 25 | 25 | 25 | 25 | 25 |
| Styrene-butadiene | H1031 | 10 | 10 | 10 | 10 | 10 | 10 |
| Co-cross-linking agent | OPE2St | 10 | 0 | 10 | 10 | 10 | 10 |
| Co-cross-linking agent | TRIAM-709 | 0 | 10 | 0 | 0 | 0 | 0 |
| Nonflammable agent | SAYTEX8010 | 113 | 113 | 113 | 113 | 113 | 113 |
| Filler | Admafine | 150 | 150 | 150 | 150 | 150 | 150 |
| Coupling agent | XBM503 | 1.2 | 1.2 | 1.2 | 1.2 | 1.2 | 1.2 |
| Curing catalyst | 25B | 4 | 4 | 4 | 4 | 4 | 4 |
| | BPO | 0 | 0 | 0 | 0 | 0 | 0 |
| Substrate | | no | no | Woven cloth | Woven cloth | Woven cloth | Woven cloth |
| | | | | No. 1 | No. 2 | No. 3 | No. 4 |
| | | | | | | | (E glass) |
| Resin content | Wt % | 100 | 100 | 52 | 53 | 52 | 49 |
| Dielectric constant | 10 GHz | 2.7 | 12.7 | 2.6 | 2.6 | 2.6 | 2.6 |
| Dielectric tangent | 10 GHz | 0.0017 | 0.0017 | 0.0011 | 0.0011 | 0.0011 | 0.0047 |
| solder heat resistance | 260° C. | — | No | No | No | No | No |
| | | | peeling-off | peeling-off | peeling-off | peeling-off | peeling-off |
| Solder heat resistance | 260° C. | — | No | No | No | No | No |
| after water adsorption | | | peeling-off | peeling-off | peeling-off | peeling-off | peeling-off |
| Modulus of elasticity at | Pa | 6.75E+08 | 1.37E+09 | — | — | — | — |
| 288° C. | | | | | | | |

TABLE 2-2
Table

| | | Example 9 | Example 10 | Example 11 | Comp. Ex. 3 | Example 12 | Example 13 |
|---|---|---|---|---|---|---|---|
| Polybutadiene | B3000 | 75 | 75 | 75 | 75 | 100 | 100 |
| Polybutadiene | RB800 | 25 | 25 | 25 | 25 | 0 | 0 |
| Styrene-butadiene | H1031 | 10 | 10 | 10 | 10 | 30 | 30 |
| Co-cross-linking agent | OPE2St | 10 | 10 | 10 | 10 | 0 | 0 |
| Co-cross-linking agent | TRIAM-709 | 0 | 0 | 0 | 0 | 0 | 0 |
| Nonflammable agent | SAYTEX8010 | 113 | 113 | 113 | 113 | 113 | 113 |
| Filler | Admafine | 150 | 150 | 150 | 150 | 150 | 150 |
| Coupling agent | KBM503 | 1.2 | 1.2 | 1.2 | 1.2 | 1.2 | 1.2 |
| Curing catalyst | 25B | 4 | 4 | 4 | 4 | 7 | 7 |
| | BPO | 0 | 0 | 0 | 0 | 4 | 4 |
| Substrate | | Non-woven | Non-woven | Non-woven | Non-woven | no | Non-woven |
| | | Cloth No. 1 | Cloth No. 2 | Cloth No. 3 | Cloth No. 4 | | Cloth No. 3 |
| Resin content | Wt % | 55 | 55 | 55 | Substrate | 100 | 55 |
| Dielectric constant | 10 GHz | 2.4 | 2.4 | 2.4 | was broken | 2.6 | 2.4 |
| Dielectric tangent | 10 GHz | 0.0009 | 0.0006 | 0.0006 | in | 0.0015 | 0.0006 |
| solder heat resistance | 260° C. | No-peeling | No-peeling | No-pealing | preparing | — | No-peeling |
| | | off | off | off | prepregs. | | off |
| Solder heat resistance | 260° C. | No-peeling | No-peeling | No-peeling | | — | No-peeling |
| after water adsorption | | off | off | off | | | off |
| Modulus of elasticity at | Pa | — | — | — | | — | — |
| 288° C. | | | | | | | |

TABLE 3

| | | | Example 14 | Example 15 | Example 16 | Example 17 |
|---|---|---|---|---|---|---|
| Nonflammable | SYTEX 8010 | φ 5.5 μm | 83 | 0 | 0 | 0 |
| agent | | φ 1.5 μm | 0 | 83 | 83 | 83 |
| Cross-linking | BVPE | — | 50 | 50 | 0 | 0 |
| agent | BMI 5100 | — | 0 | 0 | 50 | 50 |
| Co-cross linking | OPE2St | — | 117 | 117 | 117 | 117 |
| agent | | | | | | |
| Styrene-butadiene | H1043 | — | 83 | 83 | 83 | 83 |
| Filler | Admafine | φ 0.5 μm | 156 | 156 | 156 | 156 |
| Coupling agent | KBM503 | — | 1.56 | 1.56 | 1.56 | 1.56 |
| Solvent | Methylethyl | — | 77 | 77 | 77 | 77 |
| | ketone | | | | | |
| | Toluene | — | 523 | 523 | 523 | 523 |

| | | | | | |
|---|---|---|---|---|---|
| Varnish concentration | Wt % | 45 | 45 | 45 | 45 |
| Varnish viscosity | Ps | 0.4 | 0.4 | 0.2 | 0.2 |
| Precipitate amount after 24 hours | Mm | 0.5 | 0.1 | 0.1 | 0.1 |
| Substrate | — | No | No | No | No. 3 cloth |
| Resin content | Wt % | 100 | 100 | 100 | 53 |
| Dielectric constant | 10 GHz | 2.6 | 2.6 | 2.6 | 2.4 |
| Dielectric tangent | 10 GHz | 0.0015 | 0.0015 | 0.0022 | 0.0015 |

### EXAMPLE 1

Example 1 relates to a resin composition containing polyfunctional styrene compound. The cured resin composition exhibited extremely low dielectric tangent, i.e. 0.0012. Accordingly, insulating layers manufactured by the resin composition are suitable as insulating layers for high frequency electronic devices because of the low dielectric tangent.

### EXAMPLE 2

Example 2 relates to a laminate of cured prepregs prepared by impregnating the resin composition of example 1 into a substrate of woven cloth No. 3, which is composed of quartz glass fiber/polyolefin fiber. Dielectric tangent of the laminate using the quartz glass fiber and polyolefin fiber is lower than that of the cured resin composition of example 1. From the above facts, the laminate, printed wiring board, multi layer printed board that use the prepregs of example 2 have extremely low dielectric tangent, i.e. 0.0007. Solder heat resistance of the laminates was excellent regardless of water absorption or non-absorption. These laminates will exhibit excellent properties as insulators.

### EXAMPLE 3

Example 3 relates to a laminate of cured prepregs prepared by impregnating the resin composition of example 1 into a substrate of non-woven cloth No. 1, which is composed of quartz glass fiber/polyolefin fiber. Dielectric tangent of the laminate using the quartz glass fiber and polyolefin fiber is lower than that of the cured resin composition of example 1, i.e. 0.0005. Solder heat resistance of the laminates was excellent regardless of water absorption or non-absorption. From the above facts, the laminate, printed wiring board, multi layer printed board that use the prepregs of example 2 have extremely low dielectric tangent so that these laminates will exhibit excellent properties as insulators.

The laminate prepared from the prepregs of example 3 showed excellent flexibility and were machined by punching to make holes.

### COMPARATIVE EXAMPLE 1

Comparative example 1 relates to a laminate of cured prepregs prepared by impregnating the resin composition of example 1 into woven cloth No. 4 (E glass cloth). Because E glass was used, dielectric tangent of the laminate was larger than that of the resin plate of example 1, i.e. 0.0045. The dielectric tangent of the laminate is somewhat large for insulating layers of electronic devices for signal transmission of high frequency of 1 GHz or more. Even when resin compositions having low dielectric tangent are used, substrates having low dielectric tangent are necessary to lower the dielectric tangent of printed wiring boards and multi layer printed circuit boards.

### EXAMPLE 4

Example 4 relates to a resin composition that contains polybutadiene compound as a cross linking agent. The cured resin showed extremely low dielectric tangent, i.e. 0.0017 for the resin composition, which is suitable for insulating material for use in high frequency electronic devices.

### EXAMPLE 5

Example 5 relates to a resin composition that contains polybutadiene compound as a cross linking agent. As a co-cross linking agent, TRIAM-705 (trimellitic acid triallyl) was added to the composition. The cured resin showed modulus of elasticity of 1.37E+09Pa at high temperatures, which is larger than that of the resin of example 4. The dielectric tangent of the cured resin was extremely low, i.e. 0.0017. Insulating layers using the resin composition are suitable as an insulating material for high frequency electronic devices.

### EXAMPLE 6

Example 6 relates to a laminate using cured prepregs prepared by impregnating the resin composition of example 4 into woven cloth No. 1, which is composed of quartz glass fiber and polyolefin fiber. Since the woven cloth composed of quartz glass fiber and polyolefin fiber was used, the laminate exhibited smaller than that of the cured resin plate of example 4, i.e. 0.0011. The laminate, printed wiring boards and multi printed wiring boards exhibited excellent solder heat resistance regardless of water absorption or no water absorption. From the above facts, the laminate, printed wiring board, multi layer printed board that use the prepregs of example 6 have extremely low dielectric tangent so that these laminates will exhibit excellent properties as insulators.

### EXAMPLE 7

Example 7 relates to a laminate using cured prepregs prepared by impregnating the resin composition of example 4 into woven cloth No. 2, which is composed of quartz glass fiber and polyolefin fiber. Since the woven cloth composed of quartz glass fiber and polyolefin fiber was used, the laminate exhibited smaller than that of the cured resin plate of example 4, i.e. 0.0014. The laminate, printed wiring boards and multi printed wiring boards exhibited excellent solder heat resistance regardless of water absorption or no water absorption. From the above facts, the laminate, printed wiring board, multi layer printed board that use the prepregs of example 7 have extremely low dielectric tangent so that these laminates will exhibit excellent properties as insulators.

### EXAMPLE 8

Example 8 relates to a laminate using cured prepregs prepared by impregnating the resin composition of example 4 into woven cloth No. 3, which is composed of quartz glass fiber and polyolefin fiber. Since the woven cloth composed of quartz glass fiber and polyolefin fiber was used, the laminate exhibited smaller than that of the cured resin plate of example 4, i.e. 0.0011. The laminate, printed wiring boards and multi printed wiring boards exhibited excellent solder heat resistance regardless of water absorption or no water absorption. From the above facts, the laminate, printed wiring board, multi layer printed board that use the prepregs of example 8 have extremely low dielectric tangent so that these laminates will exhibit excellent properties as insulators. It has been elucidated from comparison of example 8 and examples 6, 7 that even when a content of polyolefin fiber is increased, dielectric tangent can be reduced by using mixed yarns of polyolefin fiber and quartz glass fiber.

### COMPARATIVE EXAMPLE 2

Comparative example 1 relates to a laminate of cured prepregs prepared by impregnating the resin composition of example 1 into woven cloth No. 4 (E glass cloth). Because E glass was used, dielectric tangent of the laminate was larger than that of the resin plate of example 1, i.e. 0.0047. The dielectric tangent of the laminate is somewhat large for insulating layers of electronic devices for signal transmission of high frequency of 1 GHz or more. Even when resin compositions having low dielectric tangent are used, substrates having low dielectric tangent are necessary to lower the dielectric tangent of printed wiring boards and multi layer printed circuit boards.

### EXAMPLE 9

Example 9 relates to a laminate of cured prepregs prepared by impregnating the resin composition of example 4 into a substrate of non-woven cloth No. 1, which is composed of quartz glass fiber/polyolefin fiber. Dielectric tangent of the laminate using the quartz glass fiber and polyolefin fiber is lower than that of the cured resin composition of example 4, i.e. 0.0009. Solder heat resistance of the laminates was excellent regardless of water absorption or non-absorption. From the above facts, the laminate, printed wiring board, multi layer printed board that use the prepregs of example 9 have extremely low dielectric tangent so that these laminates will exhibit excellent properties as insulators.

The laminate prepared from the prepregs of example 3 showed excellent flexibility and were machined by punching to make holes.

### EXAMPLE 10

Example 10 relates to a laminate of cured prepregs prepared by impregnating the resin composition of example 4 into a substrate of non-woven cloth No. 2, which is composed of quartz glass fiber/polyolefin fiber. Dielectric tangent of the laminate using the quartz glass fiber and polyolefin fiber is lower than that of the cured resin composition of example 4, i.e. 0.0006. Solder heat resistance of the laminates was excellent regardless of water absorption or non-absorption. From the above facts, the laminate, printed wiring board, multi layer printed board that use the prepregs of example 11 have extremely low dielectric tangent so that these laminates will exhibit excellent properties as insulators.

The laminate prepared from the prepregs of example 3 showed excellent flexibility and were machined by punching to make holes.

### EXAMPLE 11

Example 11 relates to a laminate of cured prepregs prepared by impregnating the resin composition of example 4 into a substrate of non-woven cloth No. 3, which is composed of quartz glass fiber/polyolefin fiber. Dielectric tangent of the laminate using the quartz glass fiber and polyolefin fiber is lower than that of the cured resin composition of example 1, i.e. 0.0005. Solder heat resistance of the laminates was excellent regardless of water absorption or non-absorption. From the above facts, the laminate, printed wiring board, multi layer printed board that use the prepregs of example 11 have extremely low dielectric tangent so that these laminates will exhibit excellent properties as insulators.

The laminate prepared from the prepregs of example 3 showed excellent flexibility and were machined by punching to make holes.

### COMPARATIVE EXAMPLE 3

Comparative example relates to a laminate of cured prepregs prepared by impregnating the resin composition of example 4 into non-woven cloth of quartz glass fiber. The substrate is composed of only quartz glass fiber, the cloth is poor in mechanical strength and therefore the cloth was broken in impregnation step. Accordingly, polyolefin fiber is necessary to manufacture prepregs using non-woven cloth of quartz glass fiber.

### EXAMPLE 12

Example 12 relates to a resin composition containing two types of curing catalysts and polybutadiene as a cross linking agent. Since a curing catalyst that generates radicals at low temperatures, the resin composition showed tack-free property while only polybutadiene was used as the cross linking agent. The cured resin of the composition exhibited extremely low dielectric tangent for thermosetting resin, i.e. 0.0015. The insulating layer obtained by using the resin composition exhibits low dielectric tangent, which is suitable for high frequency electronic devices.

### EXAMPLE 13

Example 12 relates to a laminate of cured prepregs prepared by impregnating the resin composition of example 12 into a substrate of non-woven cloth No. 3, which is composed of quartz glass fiber/polyolefin fiber. Dielectric tangent of the laminate using the quartz glass fiber and polyolefin fiber is lower than that of the cured resin composition of example 12, i.e. 0.0006. Solder heat resistance of the laminates was excellent regardless of water absorption or non-absorption. From the above facts, the laminate, printed wiring board, multi layer printed board that use the prepregs of example 13 have extremely low dielectric tangent so that these laminates will exhibit excellent properties as insulators.

The laminate prepared from the prepregs of example 13 showed excellent flexibility and were machined by punching to make holes.

### EXAMPLES 14, 15

Examples 14 and 15 relate to a relationship between storage stability of varnishes of the resin composition A and particle size of the nonflammable agent added to the resin composition. The smaller the particle size of the nonflammable agent, the smaller the precipitation of the nonflammable agent in the varnishes of the resin composition is achieved. Varnishes with good storage stability are good in handling and property of the resulting prepregs become well.

### EXAMPLE 16

Example 16 relates to a resin composition containing specific bismaleimide as a cross linking agent. It was confirmed that viscosity of a varnish of the resin composition containing the bismaleimide was lower than that of the resin composition containing BVPE.

### EXAMPLE 17

Example 17 relates to prepreg and cured prepreg using a resin composition that contains the specific bismaleimide as a cross linking agent and a substrate composed of quartz glass fiber and polyolefin fiber. Compared with dielectric tangent of the cured resin plate of example 16, the dielectric tangent was improved by the quartz glass fiber and polyolefin fiber.

### EXAMPLE 18

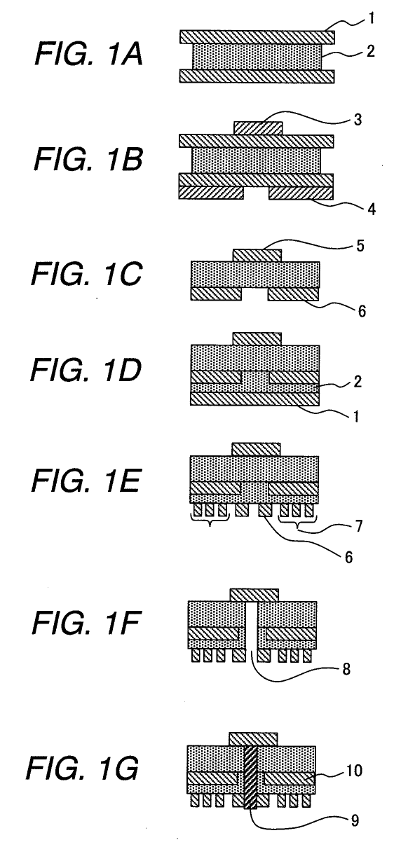

Example 18 relates to an antenna circuit built-in high frequency substrate prepared using the prepreg of example 2. A method of manufacturing the substrate is shown in FIG. 1

(A) The prepreg of example 2 was cut into 10×10 cm pieces and 10 pieces were stacked. The prepreg stack 2 was sandwiched between two copper foils 1. Under vacuum pressing of 2 MPa, a temperature was elevated at a rate of 6° C./minute to 230° C. and the stack 2 was kept for one hour at 230° C. to manufacture a copper clad laminate.

(B) Photoresist HS425 (manufactured by Hitachi Chemical Co., Ltd.) was laminated on one face of the copper clad laminate to mask a portion other than a through-hole for connecting an antenna circuit; then the resist was exposed. Thereafter, the rest of the surface of the copper clad laminate was covered with the phot0presist HS425 to expose an antenna test pattern. Then, the non-exposed portion of the resist was developed with a 1% sodium carbonate solution.

(C) The exposed copper foils were removed by etching with an etching solution containing 5% of sulfuric acid and 5% of hydrogen peroxide to make the antenna pattern 5 and through hole pattern 6. The remaining resist was removed with a 3% sodium hydroxide solution.

(D) A copper foil 1 was laminated on the through hole side, and under the same conditions of (A) the laminates were subjected to pressing to obtain a multi layer laminate.

(E) The circuit pattern 7 and through hole pattern 6 were formed in the new conductor 1 in the similar manner as in (B) and (C).

(F) A through hole 8 was formed by means of a carbon dioxide gas laser apparatus wherein the outer through hole pattern was used as a mask.

(G) Silver paste 9 was filled in the through hole 8 to connect the antenna circuit 5 with the circuit 7 on the rear side to obtain an antenna built-in printed wiring board with a shield layer 10.

What is claimed is:

1. A prepreg, which is thermosettable and comprises a thermosetting resin composition A, a cured resin of the thermosetting resin composition exhibiting a dielectric tangent of 0.005 or less under 1 GHz or more, and a substrate B into which the resin A is impregnated, wherein the substrate B comprises polyolefin fiber C and a fiber D, which has a tensile strength higher than that of the polyolefin fiber C and a thermal expansion coefficient smaller than that of the fiber C, and wherein the substrate is a woven cloth and has a solubility rate into a hydrocarbon organic solvent is less than 5 wt %.

2. The prepreg according to claim 1, wherein the substrate B is a woven cloth prepared from a yarn comprising the fiber C and fiber D.

3. A prepreg, which is thermosettable and comprises a resin composition A, a cured resin of the resin composition exhibiting a dielectric tangent of 0.005 or less under 1 GHz or more, and a substrate B into which the resin composition A is impregnated, wherein the substrate B comprises polyolefin fiber C and a fiber D, which has a tensile strength higher than that of the polyolefin fiber C and a thermal expansion coefficient smaller than that of the fiber C, and wherein the substrate is a woven cloth and has a solubility rate into a hydrocarbon organic solvent is less than 5 wt %.

4. The prepreg according to claim 3, wherein the fiber C and fiber D fused to each other.

5. The prepreg according to claim 1, wherein the fiber C contains at least one of polymers of α-olefin or its copolymers.

6. The prepreg according to claim 1, wherein the fiber D is glass fiber, which is surface-treated with a silane coupling agent.

7. The prepreg according to claim 1, wherein the fiber D is quartz glass fiber

8. The prepreg according to claim 1, wherein a glass transition temperature or melting point of the fiber C is 130° C. or higher. (Formula 1)

9. The prepreg according to claim 1, wherein the resin composition A contains polyfunctional styrene compound represented by the following general formula 1. 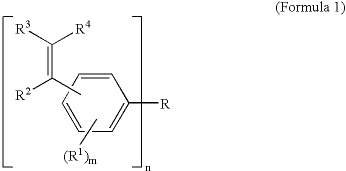
In the formula, R represents a hydrocarbon main chain, R1 a hydrocarbon group having hydrogen or hydrocarbon group having carbon atoms of 1 to 20, R2, R3 and R4 are different or the same and hydrogen or a hydrocarbon group having carbon atoms of 1 to 6, m is an integer of 1 to 4, n is an integer of 2 or more and a weight average molecular weight of the compound in a polystyrene conversion by GPC(Gel Permeation Chromatography) is 1000 or less.

10. The prepreg according to claim 1, wherein the resin composition A comprises a polybutadiene compound having repeating units represented by the following general formula and a curing catalyst for curing the polybutadiene compound. In the formula, p is an integer of 2 or more.

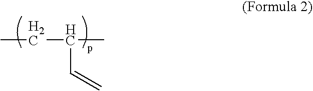

11. The prepreg according to claim 1, wherein a curing catalyst contained in the resin composition A is a complex curing catalyst, which contains 3 to 10 parts by weight of a first radical polymerization starter per 100 part by weight of the polybutadiene, the first radical polymerization starter exhibiting a half decay temperature of 80 to 140° C. for one minute and 5 to 15 parts by weight of a second radical polymerization starter exhibiting a half decay temperature of 170 to 230° C. for one minute.

12. The prepreg according to claim 1, wherein the resin composition A contains a bismaleimide compound represented by the following general formula.
In the compound, formula, R5 is the same or different hydrocarbon group containing hydrogen or carbon atoms of 1 to 4.

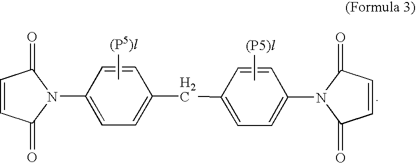

13. The prepreg according to claim 1, wherein the resin composition A contains a hydrogen added styrene-butadiene copolymer and at least one cross-linking co-agent selected from the group of curable polyphenylene oxide, trimellitic acid triallyl and pyromellitic tetra-allyl.

14. The prepreg according to claim 13, wherein the resin composition A further contains a non-flammable agent having an average particle size of 0.2 to 3.0 μm, which is represented by the following general formula 4 or 5 and silicon oxide filler.
(Formulae 4,5)

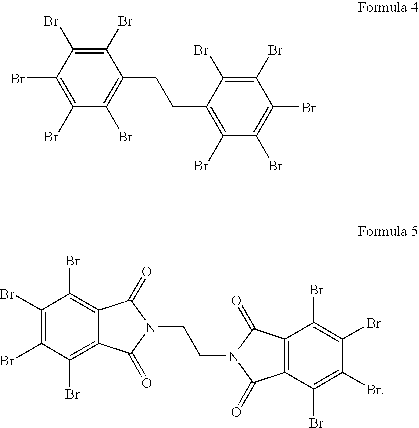

15. The prepreg according to claim 14, wherein the resin composition A further contains a silane coupling agent.

16. The prepreg according to claim 15, wherein the silane coupling agent contained in the resin composition A is supported on the silicon oxide filler.

17. A laminate, which comprises one or more of cured prepreg defined in claim 1, and one or more of conductor layers formed on one or both faces of the cured prepreg.

18. A printed wiring board, which comprises the laminate according to claim 17, wherein printed wirings are formed in the conductor layers.

19. A multi layer flexible print circuit board comprising a plurality of printed wiring boards defined in claim 1, wherein the print circuit board are laminated by bonding with prepreg, which is thermosettable and comprises a thermosetting resin composition A, a cured resin of the thermosetting resin composition exhibiting a dielectric tangent of 0.005 or less under 1 Hz or more, and a substrate B into which the resin A is impregnated, wherein the substrate B comprises polyolefin fiber C and a fiber D, which has a tensile strength higher than that of the polyolefin fiber C and a thermal expansion coefficient smaller than that of the fiber C, and wherein the substrate is a woven cloth and has a solubility rate into a hydrocarbon organic solvent is less than 5 wt %.

20. An electronic part having circuits for transferring electric signals of 1 GHz or more, which comprises the cured prepreg according to claim 1 as an insulating layer of the electronic device.
